(19) United States
(12) Patent Application Publication
(10) Pub. No.: US 2008/0164410 A1
(43) Pub. Date: Jul. 10, 2008

(54) Emission detecting analysis system and method of detecting emission on object

(75) Inventor: Ho-Jin Lee, Yongin-si (KR)

Correspondence Address: MILLS & ONELLO LLP, ELEVEN BEACON STREET, SUITE 605, BOSTON, MA, 02108, US

(73) Assignee: Samsung Electronics, Co., Ltd., Suwon-si (KR)

(21) Appl. No.: 12/004,288

(22) Filed: Dec. 20, 2007

(30) Foreign Application Priority Data
Dec. 20, 2006 (KR) 10-2006-0131080

(51) Int. Cl. G21K 7/00

(52) U.S. Cl. 250/307; 250/311

(57) ABSTRACT

According to an emission detecting analysis system and method, a test target is placed on a stage inside a chamber. A scanning electron microscope (SEM) column is installed at the chamber to obtain an image of the test target, and an emission detector column is installed at the chamber to detect light emission of the test target. High-magnification emission analysis and accurate detection of an emission point at a test target are obtained. In addition, a physical structure of the emission point is analyzed at the test target to reduce time required for analyzing a failure.

### CROSS-REFERENCE TO RELATED APPLICATIONS

This US non-provisional patent application claims priority under 35 U.S.C. § 119 of Korean Patent Application No. 10-2006-0131080 filed in the Korean Intellectual Property Office on Dec. 20, 2006, the entirety of which is hereby incorporated herein by reference.

### BACKGROUND

The present invention relates to failure analysis systems and failure analysis methods. More specifically, the present invention is directed to an emission detecting analysis system and a method of detecting emission on an object.

An emission analysis method is an analysis method for analyzing photons emitted from a test target to detect failure positions of the test target. That is, fail positions may be detected by analyzing photons generated by charge migration or concentration when wiring of an electronic circuit is abnormally opened or shorted.

As shown in FIG. 1, when predetermined current flows to wiring formed at a test target 12, leakage of the current occurs at an opened or shorted portion and a small amount of photons are emitted there. The emitted photons are analyzed by means of an emission detector 18 to detect emission points. The emission points overlap an image obtained from a CCD camera 16 to detect failure positions.

FIG. 2 illustrates diagrams illustrating a conventional emission analysis method.

Referring to FIG. 2, an image 20 obtained from a test target shows a complex structure, e.g., wiring pattern 22. A failure image 30 obtained by an emission detector 18 shows an emission point 32 having a luminance that is different from that of a periphery region 34. The two images 20 and 30 are superposed to obtain a result in which the emission point 32 is marked on the image 20 of the target photographed by a CCD camera 16.

Conventionally, an image of a test target and an emission image may be obtained by means of an optical microscope. However, the limitation in magnification of the optical microscope causes low resolution for identifying a failure position of a micro circuit. This results in the inefficiency that after detecting an emission point at a micro circuit such as a semiconductor device, a test target is carried to a separately installed scanning electron microscope (SEM) to detect a failure position. In addition, the limitation in resolving power makes it difficult to determine what portion of a pattern corresponds to the detected failure position. Furthermore, an emission point detecting and failure analysis system is a separate system, resulting in difficulty in detecting an emission point.

### SUMMARY OF THE INVENTION

Exemplary embodiments of the present invention are directed to an mission analysis system and an emission analysis method.

According to a first aspect, the present invention is directed to an mission analysis system, which may include: a chamber; a rotatable stage inside the chamber on which a test target is placed; a scanning electron microscope (SEM) column for obtaining an image of the test target; and an emission detector column for detecting a light emission of the test target.

In one embodiment, the rotatable stage has a rotation axis parallel with a stage surface.

In one embodiment, the SEM column and the emission detector column are disposed in front of the stage, and an axis of the emission detector column is inclined relative to an axis of the SEM column. An angle of the stage surface can be controllable relative to the axis of the SEM column and the axis of the emission detector column.

In one embodiment, the rotatable stage has a rotation axis perpendicular to a stage surface.

In one embodiment, the stage is parallel-movable along an orthogonal coordinate parallel with a stage surface.

In one embodiment, the emission detector column comprises an objective lens unit including a plurality of objective lenses having different magnifications.

In one embodiment, the system further comprises: an image processor for processing a detected emission image at the emission detector to adjust a magnification; an image filter for filtering an enlarged emission image to increase an accuracy of an emission point; and a superimposor for overlapping the SEM image with the emission image to mark an emission point on the SEM image.

In one embodiment, the system further comprises a focused ion beam (FIB) column installed at the chamber to etch an emission point. The FIB column can be installed in front of the stage, and an axis of the FIB column can be inclined relative to the axis of the SEM column and the axis of the emission detector column. An angle of the stage surface can be controllable relative to the axis of the FIB column, the axis of the SEM column, and the axis of the emission detector column. The rotatable stage can have a rotation axis parallel with the stage surface and a rotation axis perpendicular to the stage surface and can be parallel-movable along an orthogonal coordinate parallel with the stage surface.

According to another aspect, the invention is directed to an emission analysis method including: obtaining a scanning electron microscope (SEM) image of a test target; obtaining a failed image, where an emission point detected at the test target is marked, by means of an emission detector; and overlapping the failed image with the SEM image to mark the emission point on the SEM image.

In one embodiment, an SEM column and an emission detector column are installed to be inclined in front of a stage on which the test target is placed. An angle of the stage is controlled to make an axis of the SEM column perpendicular to a stage surface to obtain the SEM image and is controlled to make an axis of the emission detector column perpendicular to the stage surface to detect the emission point.

In one embodiment, the method further comprises: adjusting a magnification of the failed image to be equivalent to that of the SEM image for the test target. The failed image and the SEM image can overlap each other to mark a failure point on the SEM image. The method may further comprise: filtering an emission point of a failed image enlarged with a higher magnification than a failed image obtained at the emission detector to increase a position accuracy of an emission point. Luminance of the enlarged emission point can be filtered to be eliminated.

In one embodiment, the method further comprises etching the emission point of the test target using focused ion beam (FIB) to analyze a physical structure of a failure. In one embodiment, the FIB column, the SEM column, and the emission detector column are installed to be inclined in front of the stage on which the test target is placed. An angle of the stage can be controlled to make an axis of the SEM column perpendicular to a stage surface to obtain an SEM image and is controlled to make an axis of the emission detector column perpendicular to the stage surface to detect an emission point. The angle of the stage can be controlled to make the axis of the FIB column perpendicular to the stage surface to etch the test target.

### BRIEF DESCRIPTION OF THE DRAWINGS

The foregoing and other features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIGS. 1 and 2 illustrate a conventional emission analysis system.

FIGS. 3 and 4 illustrate an emission analysis system according to an embodiment of the present invention.

FIGS. 5 through 7 are images illustrating emission analysis according to an embodiment of the present invention.

FIG. 8 through 10 are flowcharts illustrating emission analysis methods according to embodiments of the present invention.

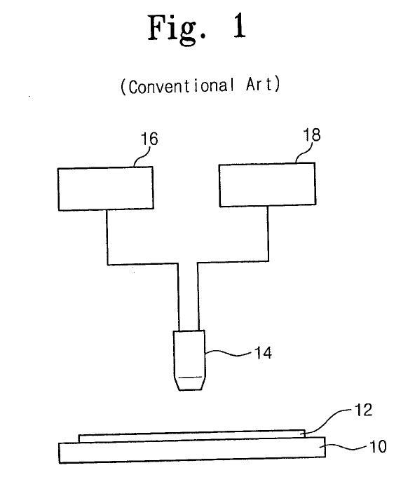

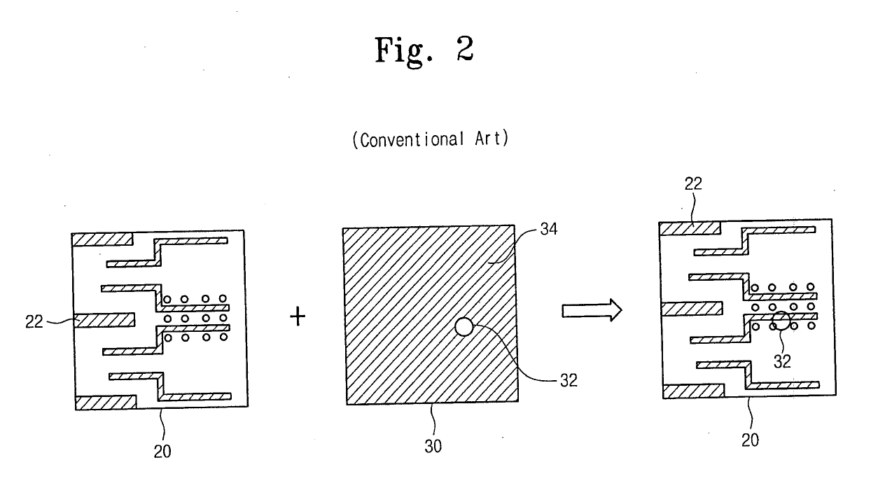

### DETAILED DESCRIPTION OF PREFERRED EMBODIMENTS

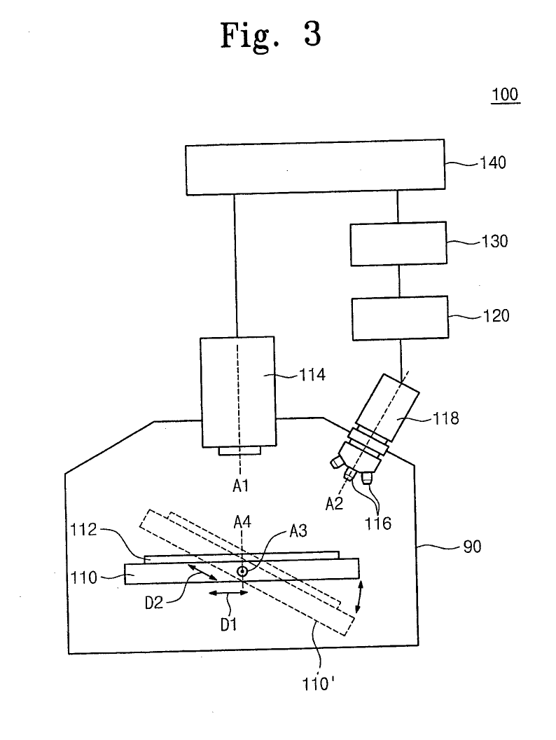

FIG. 3 illustrates an emission analysis system 100 according to an embodiment of the present invention. The emission analysis system 100 includes a chamber 90. A stage 110 is installed inside the chamber 90. A test target 112 is placed on the stage 110. A scanning electron microscope (SEM) column 114 and an emission detection column 118 are installed at the chamber 90 in front of the stage 110. An axis A1 of the SEM column 114 and an axis A2 of the emission detector column 118 are inclined at a predetermined angle.

The emission detector column 118 includes an objective lens unit including a plurality of objective lenses 116 having different magnifications. The stage 110 is configured to be rotatable and includes a rotation axis A3 that is parallel with a stage surface and a rotation axis A4 that is perpendicular to the stage surface. Also, the stage 110 is configured to be parallel-movable along orthogonal coordinates D1 and D2 of the stage surface.

The surface of the stage 110 and the axis A1 of the SEM column 114 may be perpendicularly disposed at a step of obtaining a scanning electron microscope (SEM) image. The stage 110 rotated about the axis A3 at a predetermined angle is identified as stage 110′. The surface of the stage 110′ may be disposed to be perpendicular to the axis A2 of the emission detector column 118 during the emission detection. When an SEM image is obtained and an emission is detected, the stage 110 may be parallel-translated in directions D1 and D2 parallel with the stage surface, respectively, and may rotate on the axis A4 to change the position of the test target 112.

In the present invention, an image processor 120, an image filter 130, and a superimposor 140 are provided at the emission detector column 118. The image processor 120 enlarges or reduces an emission-detected image. The image filter 130 filters and eliminates luminance lower than emission point luminance to increase accuracy of an emission-detected point. The superimposor 140 overlaps a final failed image filtered at the image filter 130 with an image obtained at the SEM column 114 to mark an emission point on an SEM image.

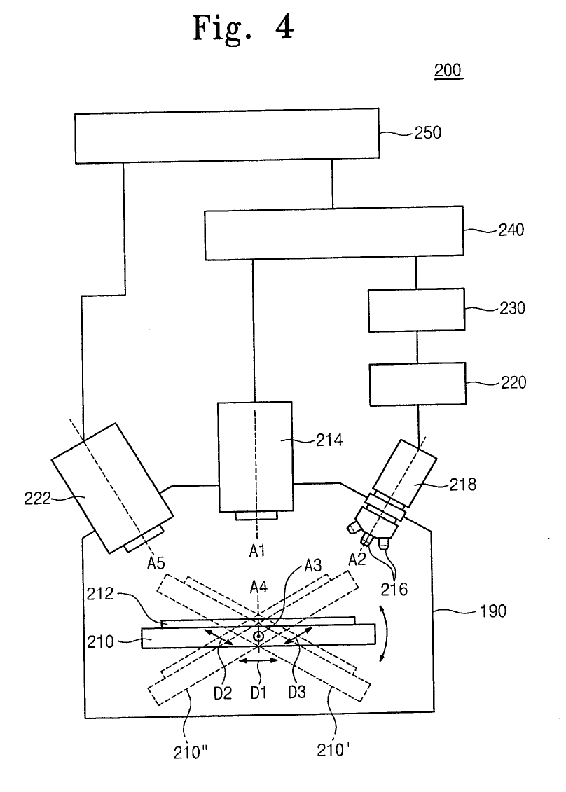

FIG. 4 illustrates an emission analysis system 200 according to another embodiment of the present invention. The emission analysis system 200 includes a chamber 190. A stage 210 is installed inside the chamber 190. A test target 212 is placed on the stage 210. A scanning electron microscope (SEM) column 214 and an emission detector column 218 are installed at the chamber 190 in front of the stage 210. A focused ion beam (FIB) column 222 is also installed at the chamber 190 in front of the stage 210. An axis A1 of the SEM column 214, an axis A2 of the emission detector column 218, and an axis A3 of the FIB column 222 are inclined at one or more predetermined angles.

The emission detector column 218 includes an objective lens unit including a plurality of objective lenses 216 having different magnifications. The stage 210 is configured to be rotatable and includes a rotation axis A3 that is parallel with a stage surface and a rotation axis A4 that is perpendicular to the stage surface. Also the stage 210 is configured to be parallel-movable along orthogonal coordinates D1 and D2 of the stage surface.

The surface of the stage 210 may be disposed to be perpendicular to the axis A1 of the SEM column 214 at a step of obtaining a scanning electron microscope (SEM) image. The stage 210 rotated about the axis A3 at predetermined angles is identified as stage 210′ and 210″, respectively. The surface of the stage 210′ may be disposed to be perpendicular to the axis A2 of the emission detector column 218 during the emission detection. The surface of the stage 210″ may be disposed to be perpendicular to the axis A3 of the FIB column 222 during an FIB etching. When the SEM image is obtained, the emission is detected, and the FIB etching is conducted, the stages 210, 210′, and 210″ may be parallel-translated in directions D1, D2, and D3 parallel with the stage surfaces, respectively, and may rotate on the axis A4 to change the position of the test target 212.

In the present invention, an image processor 220, an image filter 230, and a superimposor 240 are provided at the emission detector column 218. The image processor 220 enlarges or reduces an emission-detected image. The image filter 230 filters and eliminates luminance lower than emission point luminance to increase accuracy of an emission-detected point. The superimposor 240 overlaps a final failed image filtered at the image filter 230 with an image obtained at the SEM column 214 to mark an emission point on an SEM image. Further, a focused ion beam (FIB) controller 250 is provided at the emission detector column 218. The FIB controller 250 detects an emission point marked on the SEM image to control an FIB etching.

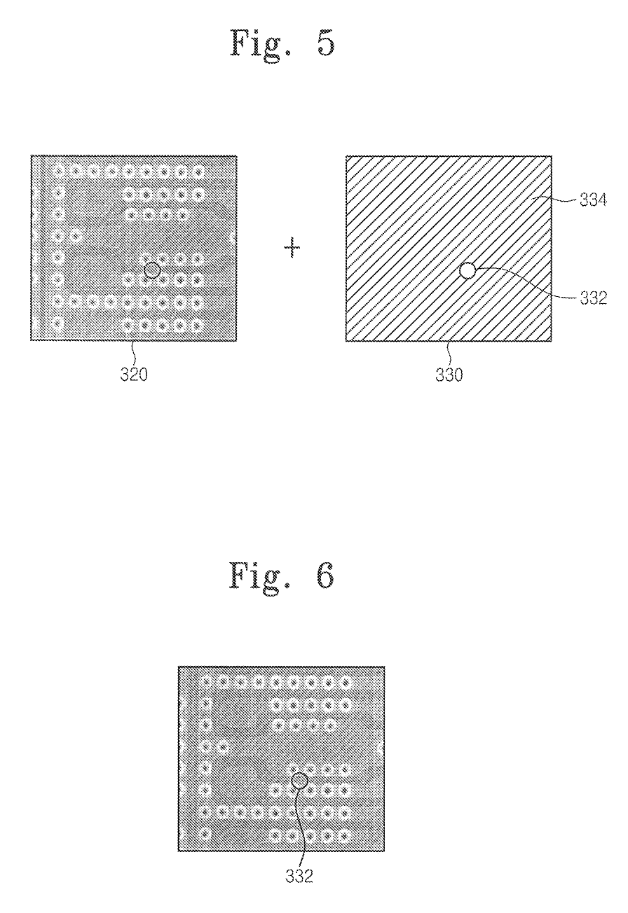

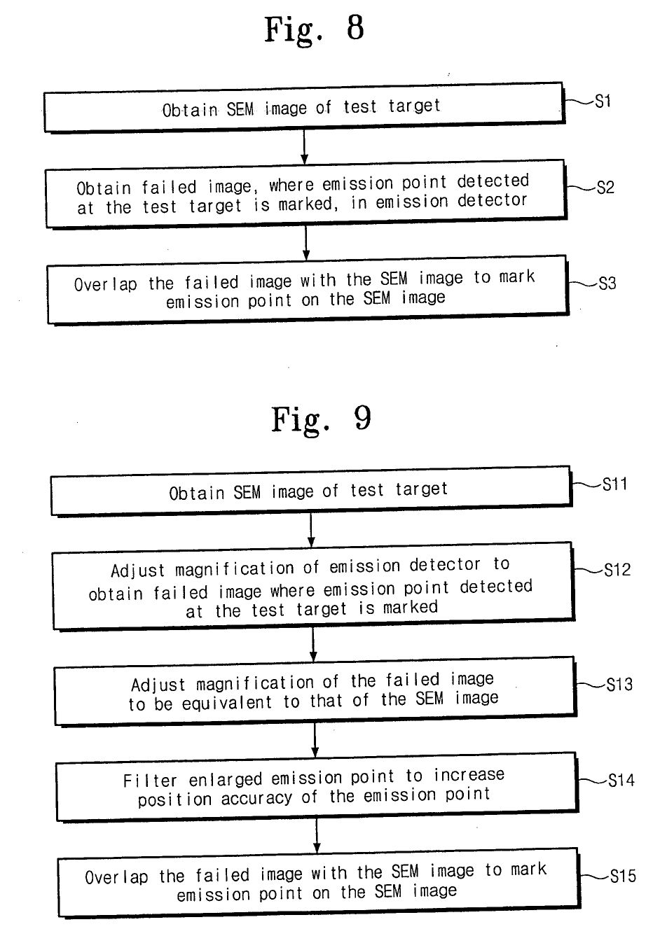

FIGS. 5 through 7 are images illustrating emission analysis according to an embodiment of the present invention, and FIG. 8 is a flowchart illustrating an emission analysis method according to a first embodiment of the present invention.

Referring to FIG. 8, a scanning electron microscope (SEM) image 320 is obtained (S1), as illustrated in FIG. 5. Since an SEM has a higher resolving power than an optical microscope, an image enlarged at a high magnification may be obtained using the SEM. Apart from an SEM image, a failed image (330 of FIG. 5) on which an emission point 332 detected from a test target is marked is obtained in an emission detector (S2). The failed images may be obtained by selecting magnifications of objective lenses installed at the emission detector column. The failed image senses photons or heat emitted from the test target, so that the emission point 332 has different luminance from a peripheral portion 334. The failed image 330 and the SEM mage 320 overlap each other to mark an emission point on an SEM image (S3), as illustrated in FIG. 6. When the SEM image 320 is obtained, the stage surface on which the test target is placed is disposed to be perpendicular to an axis of the SEM column, and the stage rotates to make the stage surface perpendicular to the axis of an emission detector column. Thus, the failed image may be obtained.

FIG. 9 is a flowchart illustrating an emission analysis method according to a second embodiment of the present invention.

Referring to FIG. 9, similar to the emission analysis method according to the first embodiment, the emission analysis method according to the second embodiment includes a step of obtaining a scanning electron microscope (SEM) image of a test target (S11). Apart from an SEM image, a failed image (330 of FIG. 5) on which an emission point 332 detected from a test target is marked is obtained in an emission detector (S12). The failed images may be obtained by selecting magnifications of objective lenses installed at an emission detector column. The failed image senses photons or heat emitted from the test target, so that the emission point 332 has different luminance from a peripheral portion 334.

Since a scanning electron microscope (SEM) may have a higher magnification than an emission detector, the SEM image 320 may have a higher magnification than the failed image 330. The present invention may further include a step of processing the failed image 330 to be enlarged (S13). Due to the enlargement of the failed image 330, the emission point is also enlarged to lower its accuracy. For this reason, the present invention includes a step of filtering the enlarged emission point to increase its accuracy (S14). Since luminance of an emission point varies with the intensity of emitted photons or heat, a portion having a lower intensity than a predetermined intensity (hereinafter referred to as “predetermined luminance”) is filtered and eliminated at an enlarged emission point to increase an accuracy of the emission point. The failed image 330 and the SEM image 320 overlap each other to mark an emission point on the SEM image (S15), as illustrated in FIG. 6. When the SEM image 320 is obtained, a stage surface on which a test target is placed is disposed to be perpendicular to an axis of an SEM column and a stage rotates to make the stage surface perpendicular to an axis of an emission detector column. Thus, a failed image may be obtained.

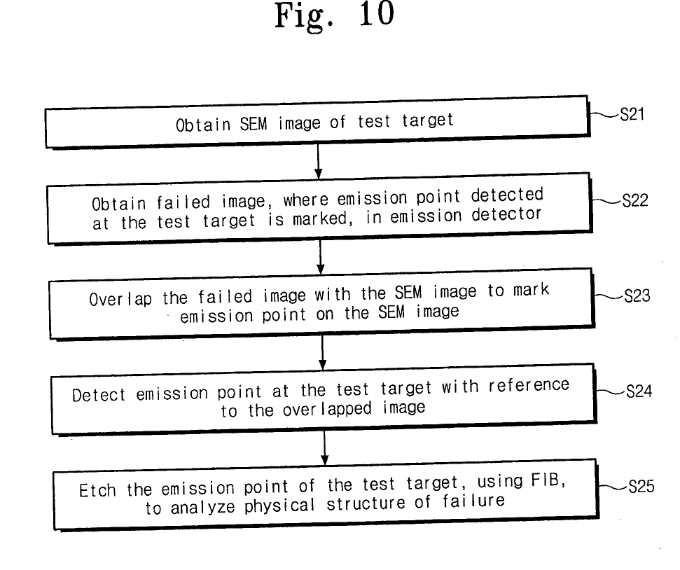

FIG. 10 is a flowchart illustrating an emission analysis method according to a third embodiment of the present invention.

Referring to FIG. 10, along with the first and second embodiments, the emission analysis method according to the third embodiment includes a step of obtaining a scanning electron microscope (SEM) image of a test target (S21), a step of obtaining a failed image, where the emission point detected at the test target is marked, in an emission detector (S22), and a step of overlapping the failed image with the SEM image to mark an emission point on the SEM image (S23).

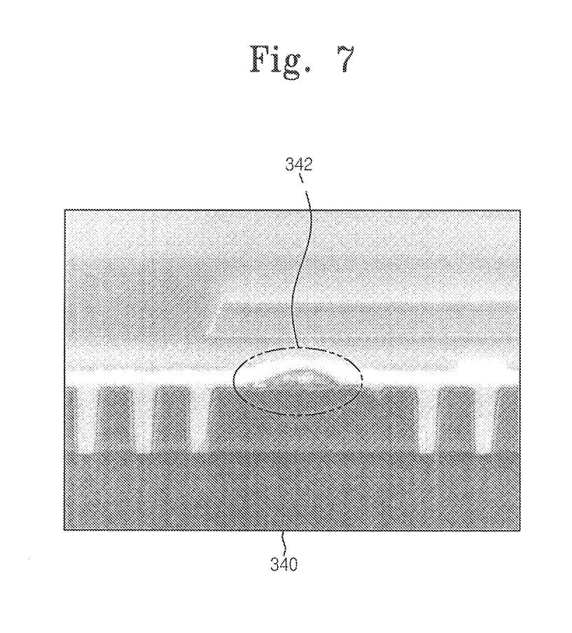

With reference to the overlapped image of the SEM image and the failed image, an emission point of the test target is detected (S24). The emission point of the test target is etched using focused ion beam (FIB) to analyze a physical structure of a failure 342 in an FIB image 340 (S25), as illustrated in FIG. 7.

In the present invention, after an emission point is etched using FIB, an image of the etched portion is obtained by means of a scanning electron microscope (SEM) installed at an emission analysis system according to the present invention to analyze a physical structure. Further, the stage rotates at a predetermined angle to analyze a structure of an FIB-etched section.

According to the present invention, it is possible to perform high-magnification emission analysis and accurately detect an emission point at a test target. A physical structure of the emission point is analyzed at the test target to reduce time required for analyzing a failure.

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the invention.

What is claimed is:

1. An emission analysis system comprising:
a chamber;
a rotatable stage inside the chamber on which a test target is placed;
a scanning electron microscope (SEM) column for obtaining an image of the test target; and
an emission detector column for detecting a light emission of the test target.

2. The emission analysis system of claim 1, wherein the rotatable stage has a rotation axis parallel with a stage surface.

3. The emission analysis system of claim 1, wherein the SEM column and the emission detector column are disposed in front of the stage, and an axis of the emission detector column is inclined relative to an axis of the SEM column.

4. The emission analysis system of claim 3, wherein an angle of the stage surface is controllable relative to the axis of the SEM column and the axis of the emission detector column.

5. The emission analysis system of claim 1, wherein the rotatable stage has a rotation axis perpendicular to a stage surface.

6. The emission analysis system of claim 1, wherein the stage is parallel-movable along an orthogonal coordinate parallel with a stage surface.

7. The emission analysis system of claim 1, wherein the emission detector column comprises an objective lens unit including a plurality of objective lenses having different magnifications.

8. The emission analysis system of claim 1, further comprising:
an image processor for processing a detected emission image at the emission detector to adjust a magnification;
an image filter for filtering an enlarged emission image to increase an accuracy of an emission point; and
a superimposor for overlapping the SEM image with the emission image to mark an emission point on the SEM image.

9. The emission analysis system of claim 1, further comprising a focused ion beam (FIB) column for etching an emission point.

10. The emission analysis system of claim 9, wherein the FIB column is installed in front of the stage, and an axis of the FIB column is inclined relative to the axis of the SEM column and the axis of the emission detector column.

11. The emission analysis system of claim 10, wherein an angle of the stage surface is controllable relative to the axis of the FIB column, the axis of the SEM column, and the axis of the emission detector column.

12. The emission analysis system of claim 11, wherein the rotatable stage has a rotation axis parallel with the stage surface and a rotation axis perpendicular to the stage surface and is parallel-movable along an orthogonal coordinate parallel with the stage surface.

13. An emission analysis method comprising:
obtaining a scanning electron microscope (SEM) image of a test target;
obtaining a failed image, where an emission point detected at the test target is marked, by means of an emission detector; and
overlapping the failed image with the SEM image to mark the emission point on the SEM image.

14. The emission analysis method of claim 13, wherein an SEM column and an emission detector column are installed to be inclined in front of a stage on which the test target is placed, and
wherein an angle of the stage is controlled to make an axis of the SEM column perpendicular to a stage surface to obtain the SEM image and is controlled to make an axis of the emission detector column perpendicular to the stage surface to detect the emission point.

15. The emission analysis method of claim 13, further comprising:
adjusting a magnification of the failed image to be equivalent to that of the SEM image for the test target,
wherein the failed image and the SEM image overlap each other to mark a failure point on the SEM image.

16. The emission analysis method of claim 15, further comprising:
filtering an emission point of a failed image enlarged with a higher magnification than a failed image obtained at the emission detector to increase a position accuracy of an emission point.

17. The emission analysis method of claim 16, wherein luminance of the enlarged emission point is filtered to be eliminated.

18. The emission analysis method of claim 13, further comprising etching the emission point of the test target using focused ion beam (FIB) to analyze a physical structure of a failure.

19. The emission analysis method of claim 18, wherein the FIB column, the SEM column, and the emission detector column are installed to be inclined in front of the stage on which the test target is placed,
wherein an angle of the stage is controlled to make an axis of the SEM column perpendicular to a stage surface to obtain an SEM image and is controlled to make an axis of the emission detector column perpendicular to the stage surface to detect an emission point, and
wherein the angle of the stage is controlled to make the axis of the FIB column perpendicular to the stage surface to etch the test target.
